(19) United States
(12) Patent Application Publication
(10) Pub. No.: US 2012/0179619 A1
(43) Pub. Date: Jul. 12, 2012

(54) Method for Recouping Tuition Discounts

(76) Inventors: Joseph P. Moorer, JR., Ponte Vedra Beach, FL (US); James B. Johnston, Philadelphia, PA (US)

(21) Appl. No.: 13/346,672

(22) Filed: Jan. 9, 2012

Related U.S. Application Data
(60) Provisional application No. 61/460,818, filed on Jan. 7, 2011.

(51) Int. Cl. G06Q 50/20

(52) U.S. Cl. 705/327

(57) ABSTRACT

A tuition advantage program incorporating an award offered to students via a promissory note, and having an original principal balance that replaces a small part of the institutional tuition discount that the institution extends to the student. The principal is a reduction against tuition, and it is not delivered to students in the form of a payment. Extension of the principal therefore results in no direct expense to the institution, as it is merely a transformation of a discount that otherwise would have been granted to the student in the form of institutional aid award. Repayment of the tuition advantage funds is not required until after the student separates from the institution, such as by graduation. Upon separation and timely repayment of the first 75% of the original principal balance, the remaining 25% of the original principal is forgiven, resulting in an effective annual percentage rate of under 1.0%.

### RELATED APPLICATION

This application claims the benefit of U.S. Provisional Patent Application Ser. No. 61/460,818, filed on Jan. 7, 2011, the contents of which are hereby incorporated in their entirety by this reference.

### BACKGROUND OF THE INVENTION

This invention relates generally to the field of methods and systems for reducing losses incurred by academic institutions that extend discounted tuitions to students, which most commonly occurs for private independent colleges and universities. Over the past 15 years, the competitive environment in higher education has led to steep tuition discounts at private independent colleges. The average discount rate has increased from 25% to 42% from 1993 to 2008. Tuition discounts are granted to students to insure that enrollment numbers reach desirable levels to address the fixed institution costs. Because many second tier liberal art universities charge tuition similar to tuition charged at top tier universities, it is necessary to grant discounts to attract students. It is not uncommon for up to 80% of the students to receive discounted tuition, which results in significant loss of revenue to the institutions. The tuition discounts are typically designated grants or merit aid, but are sometimes expressly designated as discounted tuition.

It is an object of this invention to provide a system and method that recaptures a portion of the discounted tuition for the benefit of the institution. The system and method increases net tuition revenue, decreases the tuition discount, does not result in any cost to the institution, is low cost to the students and improves retention of enrolled students.

### SUMMARY OF THE INVENTION

The deferred award and payment plan offered to students is a promissory note, co-signed by parents or guardians, and having an original principal balance. This principal replaces a small part of the tuition discount that the institution extends to the student. The principal is a reduction against tuition, and it is not delivered to students in the form of a payment. The extension of the principal therefore results in no direct expense to the institution, as it is merely a transformation of a discount that otherwise would have been granted to the student in the form of institutional aid award. Repayment of the tuition advantage funds is not required until after the student separates from the institution, such as by graduation. Upon graduation and timely repayment of the first 75% of the original principal balance, the remaining 25% of the original principal is forgiven. Because of the back-end forgiveness feature, the effective annual percentage rate (“APR”) paid by the student will be under 1.0%, and close to 0% in some cases.

In one embodiment for an institution having 2,000 students, the tuition advantage program will generate from $700,000 to $1,000,000 in revenue that would not have been realized by the institution if those amounts had been awarded in the form of tuition discounts. By consolidating a large number of the deferred promissory notes from an institution, and then pooling the assets from many institutions, the bundled notes may be sold to investors, thereby providing institutions with an influx of cash.

Implementation of the tuition advantage program requires interfacing with multiple institutions through Internet communication and the use of specially programmed computer software to track the awards. Individual institutions will have multiple options in the terms and conditions of the tuition advantage programs, and may adopt institution-wide standards or customize the program in relation to individual students.

The system and method further comprises securitizing the loans in order to recapture and return a portion of the discount to the institution.

### BRIEF DESCRIPTION OF THE DRAWINGS

FIG. 1 is a flow chart showing implementation of one embodiment of the tuition advantage program.

FIG. 2 is a flow chart showing implementation of an alternate embodiment of the tuition advantage program.

FIG. 3 is a table showing additional detail for designated steps incorporated in the flow charts shown in FIGS. 1 & 2.

### DETAILED DESCRIPTION

Referring to the Figures, various embodiments of an exemplary tuition advantage program, and components thereof, are described and shown. A tuition advantage program according to principles of the invention permits replacing a small portion of the tuition discounts that institutions extend to students with a deferred award and payment plan having a back-end forgiveness feature. The system and method further comprises pooling the assets of many institutions and securitizing the portion of the discount transformed into awards in order to recapture and return a portion of the discount to the academic institution.

The embodiments disclosed herein are meant for illustration and not limitation of the system. An ordinary practitioner will understand that it is possible to create other variations of the following embodiments without undue experimentation. For example, the following discussion is in the context of an undergraduate university or college setting. An ordinary practitioner will understand that the tuition advantage program could also be applied to tuition expenses for private high school education and a variety of other tuition programs. For the purposes of this discussion, “institution” means a college, university, or other academic institution that extends to students one or more forms of tuition assistance, grants, discounts, forgiveness, or other such tuition aid.

The system generally comprises a physical, computer readable medium containing program instructions for implementing a segmentation algorithm, as discussed in more detail below. The physical, computer readable media is any physical device capable of storing electronic data, such as a physical, magnetically or optically readable medium. The computer is a computing device configured to access and run the program instructions for carrying out the segmentation algorithm, including electronically performing the calculations and logic sequences required by the algorithm. The system is established and operated by a provider that offers membership to institutions for the benefit of the institution and that of the students.

The deferred award and payment plan offered to students is a promissory note, co-signed by parents or guardians, and having an original principal balance. This principal replaces a small part of the tuition discount that the institution extends to the student. For example, the original principal balance in the note could be $2,000 per year. The principal is a reduction against tuition, and it is not delivered to students in the form of a payment. The extension of the principal therefore results in no direct expense to the institution, as it is merely a transformation of a discount that otherwise would have been granted to the student in the form of institutional aid award. Repayment of the tuition advantage funds is not required until after the student separates from the institution, such as by graduation. Upon graduation and timely repayment of the first 75% of the original principal balance, the remaining 25% of the original principal is forgiven. Because of the back-end forgiveness feature, the effective annual percentage rate (“APR”) paid by the student will be under 1.0%, and close to 0% in some cases, making the award extremely attractive to students. For example, in one embodiment of the tuition advantage program, a ten-year $2,000 tuition advantage award, the total repayment of interest plus 75% of the principal is only $2,000.00, resulting in a zero percent (0%) APR repayment plan.

In one embodiment for an institution having 2,000 students, the tuition advantage program will generate from $700,000 to $1,000,000 in revenue that would not have been realized by the institution if those amounts had been awarded in the form of tuition discounts. By consolidating a large number of the deferred promissory notes from an institution, and then pooling the assets from many institutions, the bundled notes may be sold to investors, thereby providing institutions with an influx of cash.

In terms of methodology, the following steps generally comprise the tuition advantage program. As an initial step, the institution becomes member of tuition advantage program administration and implementation network. The institution and provider, using tuition advantage data collection programs and computer implemented algorithms, then determine the target population at the institution that would most benefit from the tuition advantage program. The components to this analysis are described below.

### Income Segmentation Model

In the income segmentation model, an algorithm analyzes various elements from the institution's historical data to identify specific student population(s) that would benefit from the tuition advantage program, with the goal of having little or no effect on the institution's yield (the number of students who enroll at the institution divided by the number of students who were accepted). The steps in the segmentation process are as follows:
a. Data is electronically gathered from an historical academic institution database, such as the Integrated Postsecondary Education Data System (IPEDS) database, using a computer to access the database via an electronic network, such as the Internet or an intranet. The IPEDS is a database produced annually by the U.S. Department of Education based on required submissions from all post-secondary institutions that are eligible for federal aid.
b. The data is analyzed to determine numerous components that relate to the institution's patterns for awarding aid to students, including but not limited to the following:
   (1) Number of students, by grade level;
   (2) Retention levels, both year over year and freshman to graduation;
   (3) Federal aid awarded, in terms of (i) need-based aid, and (ii) non-need based aid;
   (4) Institutional aid awarded, in terms of (i) need-based aid, and (ii) non-need based aid;
   (5) Combination of federal and institutional aid (one, both, or neither);
   (6) Number of students who have completed the Free Application for Federal Student Aid (FAFSA);
   (7) Aid distribution by annual income level of the student's family; and
   (8) Number of students receiving federal student loans (Perkins, Direct Student Loans, or the like).
c. In addition to the data collected from IPEDS, input to the algorithm will also include the following institution-specific components for the first four years of the program:
   (1) The target number of students to be offered the tuition advantage award, which is based on the reduction in the discount rate the institution is trying to achieve;
   (2) The desired implementation patterns, for example whether the program be offered to all grade levels initially, or only certain grades (i.e., start with freshmen in year one, then expand as that grade matriculates, or start with only upper-classmen, or start with all grade levels immediately);
   (3) The desired utilization rates, which are the rates in which the program be phased in by awarding tuition advantage funds to students. For example, the utilization rate could be based on a target of 20% of students in year one, 40% in year two, etc. Alternatively, the utilization rate could be 100%, meaning that the program will it be awarded to all students immediately.
   (4) Anticipated tuition increases over the four year period.
d. The data gathered in steps b. and c. above are entered into a “segmentation algorithm,” which is used to determine a target breakdown of students to receive tuition advantage awards. In most instances, students are categorized according to their family income level, and the segmentation algorithm is used to determine how many students in each category will receive awards. The segmentation algorithm applies the following sequence of calculations:
   (1) Identify the institution's cost of attendance (“COA”) compared to similar sector institutions (public, private, community college, for-profit, etc.). Each institution falls into one of four categories:
      (a) High COA>1.25×average;
      (b) Above Average COA>1.00×average, and <1.25×average;
      (c) Below Average COA>0.75×average, and <1.00×average; and
      (d) Low COA <0.75×average.
   (2) Sort the students receiving institutional aid by the family's annual income category as identified by the IPEDS data, additionally identifying those whose income was not reported (these are the students who did not file a Free Application for Federal Student Aid, or FAFSA). The income categories are as follows:
      (a) No Income Data
      (b) $110,001 and above
      (c) $75,001-$110,000
      (d) $48,001-$75,000
      (e) $30,001-$48,000
      (f) $0-$30,000
(3) Use the data gathered from the historical academic institution database to identify the manner in which the institution has historically awarded its institutional aid dollars across the income categories. This step compares historical awards within income categories to those at similar institutions, such as by comparing the COA, number of students, geographic location and academic level. This data comparison considers both the number of students who were historically awarded institutional aid in each category and the dollars awarded to each. The comparison then identifies (i) areas where the subject institution is awarding aid at a significantly higher or lower rate for certain income categories; and (ii) the effect that this over-or under-awarding has on the retention rates compared to similar institutions. For instance, the algorithm may identify that an institution is awarding an average of $8,600 to 75% of the students in the $75,000-$110,000 income category, and the analysis shows that other schools in its cohort are awarding an average of $7,200 to 60% of the students in that group. The subject institution may be able to reduce both the number of awards and the average amount awarded with little or no risk. Using an example of 50 students in this category, by lowering only the amount of dollars per award to the average level, the subject institution could realize a $54,000 reduction in revenue lost to institutional tuition aid. By reducing only the number of awards to the average number extended by comparable institutions, the subject institution could realize a $42,000 reduction in revenue lost to institutional tuition aid. By lowering both their respective averages, the total effect would translate into a $106,500 reduction in lost tuition.
   (4) Establish maximum guidelines for the segmentation percentages in each income category for institutions with High COA. One embodiment of the income distribution by income level is assigned as follows:

| (a) | No Income Data | Up to 75% |
|---|---|---|
| (b) | $110,001 and above | Up to 50% |
| (c) | $75,001-$110,000 | Up to 30% |
| (d) | $48,001-$75,000 | Up to 10% |
| (e) | $30,001-$48,000 | Zero |
| (f) | $0-$30,000 | Zero |

(5) Establish maximum guidelines for the segmentation percentages in each income category for institutions with Above Average COA. One embodiment of the income distribution by income level will be assigned as follows:

| (a) | No Income Data | Up to 75% |
|---|---|---|
| (b) | $110,001 and above | Up to 50% |
| (c) | $75,001-$110,000 | Up to 25% |
| (d) | $48,001-$75,000 | Up to 15% |
| (e) | $30,001-$48,000 | Up to 10% |
| (f) | $0-$30,000 | Zero |

(6) Establish maximum guidelines for the segmentation percentages in each income category for institutions with Below Average COA. One embodiment of the income distribution by income level will be assigned as follows:

| (a) | No Income Data | Up to 60% |
|---|---|---|
| (b) | $110,001 and above | Up to 75% |
| (c) | $75,001-$110,000 | Up to 50% |
| (d) | $48,001-$75,000 | Up to 50% |
| (e) | $30,001-$48,000 | Up to 50% |
| (f) | $0-$30,000 | Zero |

(7) Establish maximum guidelines for the segmentation percentages in each income category for institutions with Low COA. One embodiment of the income distribution by income level will be assigned as follows:

| (a) | No Income Data | Up to 50% |
|---|---|---|
| (b) | $110,001 and above | Up to 75% |
| (c) | $75,001-$110,000 | Up to 75% |
| (d) | $48,001-$75,000 | Up to 60% |
| (e) | $30,001-$48,000 | Up to 30% |
| (f) | $0-$30,000 | Up to 30% |

An alternate embodiment can be implemented in situations where the segmentation algorithm renders a recommendation across two or fewer of the categories described (or if there is a statistically-insignificant number in additional categories), the computer readable medium is programmed with instructions for implementing a “rebalancing algorithm” to expand the target population to at least three income categories. The rebalancing algorithm (i) eliminates the target population initially identified; (ii) reapplies the segmentation algorithm logic as if the students in the identified target population were not a part of the original group, thus generating a secondary distribution; and (iii) combines the original segmentation results with the results from the secondary distribution to create a recommendation in line with the institution's requested utilization rates. The original segmentation results and the secondary distribution can be combined in the form of an average, weighted average, factored multiplication, or by other means suited for the particular circumstance.

The variation in the maximum percentage assigned by income category and by COA is mainly a factor of the make up of the “No Income Data” category. At more expensive institutions, this category is mostly comprised of families who do not fill out the FAFSA because they assume that they are ineligible for any aid, and choose not to complete it because there is no perceived benefit. At the institutions with lower COA, some do not fill out the FAFSA for the same reason, though others do not fill it out simply because they are not aware of the benefits of doing so. Therefore, at the lower cost institutions, fewer in that category are likely to be targets of the tuition advantage program.

Based on the results of the tuition advantage segmentation algorithm, specific recommendations are made to the institution as to which target student population(s) will benefit from the tuition advantage award. An example of the output is shown in the Tables below.

TABLE 1.1
Identifying Cohorts and Tuition Advantage
Strategy Generic University

| Full Time, First Time Undergraduates | 612 |
|---|---|
| Receiving Institutional Aid | 508 |
| Family Income Level | Students |
| $110,001-Above | 150 |
| $75,001-$110,000 | 68 |
| $48,001-$75,000 | 53 |
| $30,001-$48,000 | 32 |
| 0-$30,000 | 34 |
| Receiving Title IV Federal Student Aid | 337 |

In this example, the institution seeks to offer the program to 25% of its freshman class, or 156 students. The table below shows the award breakdown by student, or “cohort,” groupings based on the segmentation algorithm. In this particular instance, the rebalancing algorithm has also been applied.

TABLE 1.2

| | | Target | Students |
|---|---|---|---|
| | | % Awarded | Awarded |
| | | Tuition | Tuition |
| Group of Students | Students | Advantage | Advantage |
| Students not receiving institutional | 104 | 0% | 0 |
| aid | | | |
| Not receiving federal aid but | 171 | 73% | 125 |
| receiving institutional aid | | | |
| Receiving federal aid and receiving | 150 | 15% | 23 |
| intuitional aid, Income $110k+ | | | |
| Receiving federal aid and receiving | 68 | 12% | 8 |
| intuitional aid, Income $75-$110k | | | |
| Receiving federal aid and receiving | 53 | 0% | 0 |
| intuitional aid, Income $48-$75k | | | |
| Receiving federal aid and receiving | 32 | 0% | 0 |
| intuitional aid, Income $30-$48k | | | |
| Receiving federal aid and receiving | 34 | 0% | 0 |
| intuitional aid, Income $0-$30k | | | |
| TOTAL | 612 | 100% | 156 |

In Table 1.2, the “students not receiving institutional aid” is assumed to be the difference between the full time, first time undergraduates (612) and those receiving institutional aid (508). The “not receiving federal aid but receiving institutional aid” is assumed to be the difference between the cohorts receiving institutional aid (508) and those receiving federal student aid (337). The model in this example shows that the biggest target population is the families who have received institutional aid, but no federal aid. Additional populations are the higher income cohorts that did receive some federal aid.

In this example, the institution has indicated it would like about a 25% utilization rate for its freshman in the first year. These data are used as input to the segmentation algorithm, telling it to identify 147 to 159 students (612 freshman×24% & 26%, respectively) as the target population. In many instances, such as this one, a range is used to generate whole numbers of students under the statistically small sample size. The segmentation algorithm then determines, based on the specific situation at the institution, which income categories these students should come from. In this case, 73%, or 125 of the students should come from these students who do not receive federal aid and do receive institutional aid, 12%, or 8 students should come from the category that receive both types of aid and whose families earn between $75K and $110K per year, and 15%, or 23 students should come from those who make more than $110K per year.

Analysis of this example shows that the institution will recoup significant levels of tuition proceeds, as shown in Table 1.3.

TABLE 1.3
Institutional Aid Statistics

| | |
|---|---|
| Total Institutional Aid to Freshmen | $11,200,000 |
| Institutional Aid to Cohort | 508 |
| Average Aid per Student | $22,047 |
| Total number of cohorts (from Table 1.2) | 156 |
| Total Current Aid Given to All Cohorts | $3,439,332 |

In Table 1.3, the “total current aid given to all cohorts” is based on the average institutional aid per student at the institution. The increased revenue realized by the institution varies with the percentage of total aid given under the tuition advantage program, as shown in Table 1.4 below.

TABLE 1.4

| % of Total Institutional Aid | | | | | |
|---|---|---|---|---|---|
| Given As Tuition Advantage | 3% | 4% | 5% | 6% | 7% |
| Total Tuition Advantage Amount | $336,000 | $448,000 | $560,000 | $672,000 | $784,000 |
| Average Tuition Advantage | $2,154 | $2,872 | $3,590 | $4,308 | $5,026 |
| Awarded per Student | | | | | |
| Increased Revenue | $126,000 | $168,000 | $210,000 | $252,000 | $294,000 |

### Discount Model

The underlying purpose of the tuition advantage program is to help institutions reduce, or at least maintain, their current discount rates. Tables 2.1 & 2.2 show the savings the institution will realize once it has established its segmentation plan. In this example, the institution from the example above has a goal to reduce its discount rate from 58% to 52% over the four year period, increasing the utilization to 80% of students by year four. The model shows that the institution will recapture $1.6 million per year by the fourth year of the tuition advantage program.

TABLE 2.1
Enrollment and Discount Statistics

| | |
|---|---|
| Total Enrollment | 2,400 |
| Tuition and Fees | $38,000 |
| Average Institutional Aid | $22,000 |
| Stated Tuition Revenue | $91,200,000 |
| Estimated Discount | 58% |
| Tuition Lost to Discount | $52,896,000 |
| Net Tuition Revenue | $38,304,000 |

Based on this 58% discount rate, Table 2.2 shows how the institution's revenue increases each year by reducing the discount rate by an extra 1% each year. The “revised discount rate” is the original 58% less the rate reduction for each given year.

TABLE 2.2

| Reduce Discount Rate by: | 3% | 4% | 5% | 6% | 7% |
|---|---|---|---|---|---|
| Revised Discount Rate: | 55% | 54% | 53% | 52% | 51% |
| Revised Discounted Dollars: | $20,900 | $20,520 | $20,140 | $19,760 | $19,380 |
| Tuition Advantage Awarded Amount: | $1,140 | $1,520 | $1,900 | $2,280 | $2,660 |
| Increased Revenue | $820,800 | $1,094,400 | $1,368,000 | $1,641,600 | $1,915,200 |

In this example, the reduction in the discount rate, or unfunded institutional aid, is achieved by providing a tuition advantage award to students in lieu of scholarships or grants. In Table 2.2, all increased revenue amounts are assumed at 80% utilization and a 37.5% securitization rate.

### Gap-Filling Model

A gap-filling model of the tuition advantage program shows how the program can be used to assist the institution with retention of students. By using the program to fill a financial gap for students who would otherwise leave institution due to financial concerns, institutions can retain those students and be far better off financially. The model shows that for each student that leaves, the institution will lose approximately $15,960 ($38,000×(100%−58%)). By providing some assistance with the tuition advantage program, the institution can recapture its net tuition revenue for each student for that year and potentially additional years, and improve its retention rate. The following tables illustrate one example of this gap-filling model:

TABLE 3.1
Enrollment and Retention Statistics

| | |
|---|---|
| Total Number of Undergraduate Students Enrolled | 2,400 |
| Retention Rate | 92% |
| Students Retained | 2,208 |
| Students that Leave | 192 |
| Stated Tuition | $38,000 |
| Discount Rate | 58% |
| Net Tuition Per Student | $15,960 |
| Net Tuition Revenue (after discount) | $38,304,000 |
| Revenue Retained | $35,239,680 |
| Revenue Lost Due to Attrition | $3,064,320 |

In this example for a generic university, the “net tuition per student” includes student loans, grants, scholarships, monetary contributions by family, and the like. The “revenue lost due to attrition” is the number of students that leave (192) multiplied by the net tuition revenue per student ($15,960). The revenue recaptured by offering the tuition advantage awards is as follows:

TABLE 3.2

| | |
|---|---|
| Students that Leave (see Table 3.1) | 192 |
| Percentage That Leave Due to Financial Considerations | 5% (Estimate) |
| Total Students That Leave Due to Unmet Need Based on Percentage Above | 10 |
| Net Tuition Revenue Lost Per Student | $15,960 |
| Total Net Tuition Revenue Lost | $159,600 |

TABLE 3.3

| | Current | | | | | |
|---|---|---|---|---|---|---|
| | Strategy | Determine Amount of Unmet Need per Student | | | | |
| Tuition Advantage Amount | $0 | $1,000 | $2,000 | $3,000 | $4,000 | $5,000 |
| Tuition Revenue Recaptured | $0 | $14,960 | $13,960 | $12,960 | $11,960 | $10,960 |
| Total Net Revenue Recaptured | $0 | $149,600 | $139,600 | $129,600 | $119,600 | $109,600 |
| Additional Tuition Advantage | $0 | $3,750 | $7,500 | $11,250 | $15,000 | $18,750 |
| Revenue | | | | | | |
| Increased Revenue | $0 | $153,350 | $147,100 | $140,850 | $134,600 | $128,350 |

In Tables 3.2 and 3.3, filling the gap between financial need an assistance is achieved by providing the tuition advantage awards to students that otherwise cannot afford the cost of tuition. The “tuition revenue recaptured” is the net tuition revenue ($15,960) less the tuition advantage award given to retain students (e.g. $1,000 in the first scenario). The “additional tuition advantage revenue” is calculated as the award amount ($1,000 in the first scenario) multiplied by the number of students receiving this award (10 in this example) multiplied by the securitization rate, which is 37.5% in this example.

### General Procedure

Once the number of students and amount of award are determined according to the principles above, the institution offers the tuition advantage award to student. The institution sends an award certification to the provider. The recipient student and, where necessary, cosigner apply for and agree to terms of the award.

The provider indicates to the institution which students and cosigners have been approved to receive the award. The institution and the provider work together to determine the date on which proceeds are credited to the student's account. At all times the tuition advantage administration and implementation network is maintained by the provider. This will include the critical student information for all students at all institutions.

Six months after a borrower graduates or is no longer enrolled for other reasons, the tuition advantage award will enter repayment status. For recipient students who graduate and make all of their payments on time, the final 25% of the original principal balance of the tuition advantage promissory note will be forgiven.

As tuition advantage awards approach their repayment start dates, awards from all institutions will be combined into one trust estate, with each institution retaining a pro-rated share of the benefits of the trust. The pool will be offered to institutional investors. This securitization process will provide cash payments to the institutions on their pro-rata share of the trust. The initial securitization will take place 3½ to 4 years after the initial awards are made, with annual securitizations thereafter. It is anticipated that institutions will receive approximately 37½% of the original principal balance of their award pool in each securitization. The investors will reduce the payment amount first by the 25% potential forgiveness amount, then by 50% of that amount for overcollateralization.

Because of these discounts, the security created for the investors by the tuition advantage administration and implementation network will be paid before the award assets have been paid in full. It is estimated that the term of the security will be 4½-5 years, while the repayment term on the underlying awards will be 10 years. Once the investors have been paid in full, the tuition advantage administration and implementation network will distribute the residual value of the awards in the trust to each individual institution on a pro-rated basis. The exact amount of the residual payments will be determined by the number of recipient students who ultimately obtain the graduation and repayment benefits, and the number of recipient students who default on their obligations.

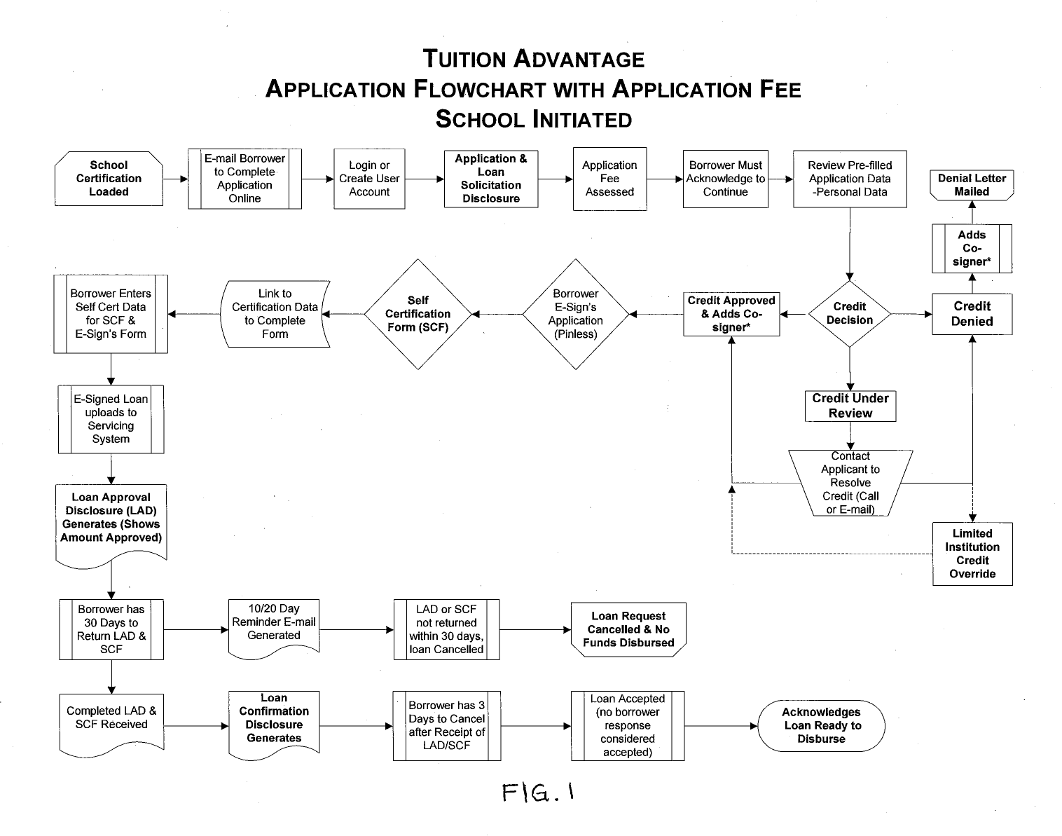

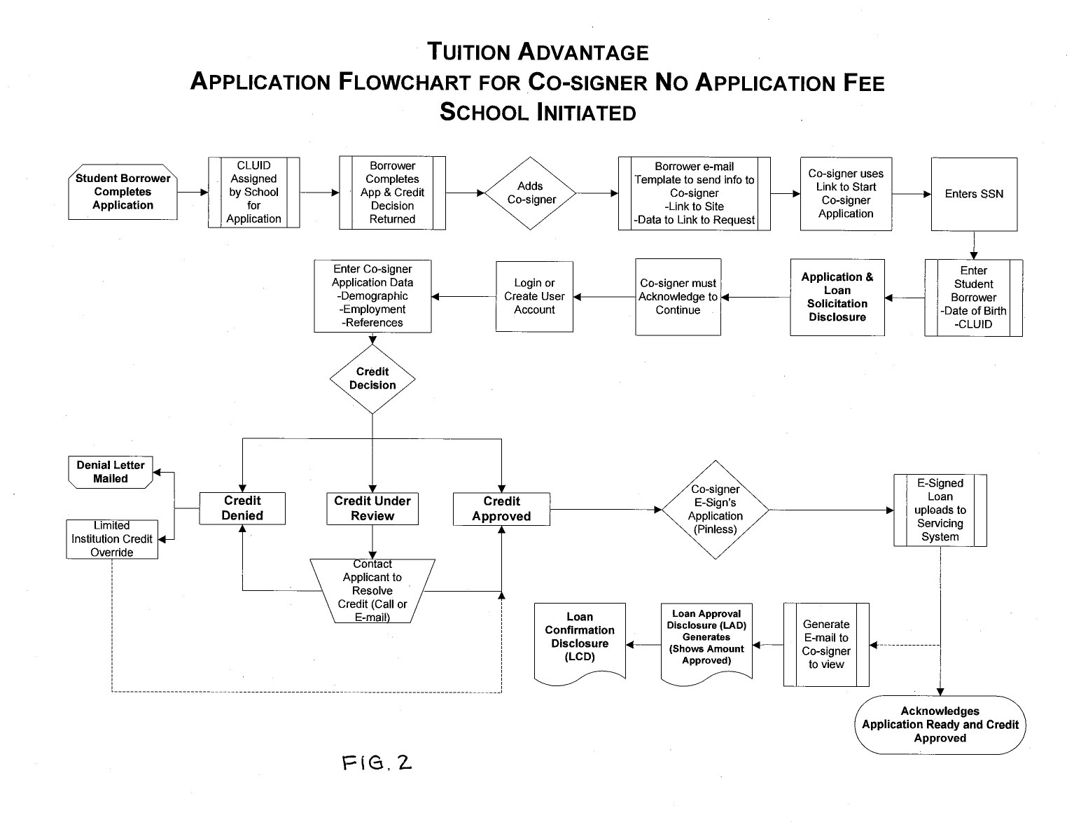

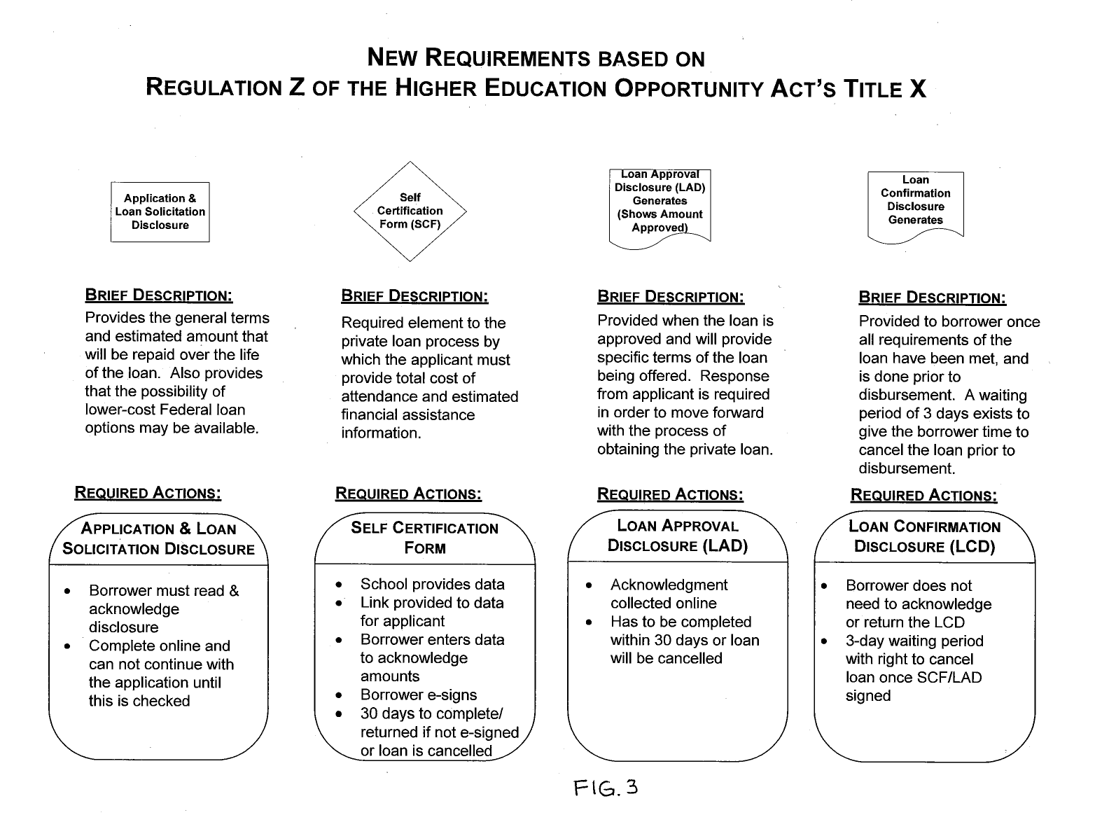

In one embodiment of the tuition advantage program, shown in flowchart in FIG. 1, the award comprises a loan to the student. Most of the steps of this embodiment are explained in FIG. 1. One particular item of interest is the addition of a co-signer, shown in the flowchart in FIG. 2. Other specific items of interest are further explained in FIG. 3.

The foregoing embodiments are merely representative of the tuition advantage program and not meant for limitation of the invention. For example, one having ordinary skill in the art would understand that many components described herein can be customized for specific applications by an ordinary practitioner. Several components of the tuition advantage program may be adapted for use by specific institutions or to accommodate specific financial conditions of either the institution or the recipient students. Consequently, it is understood that equivalents and substitutions for certain elements and components set forth above are part of the invention, and therefore the true scope and definition of the invention is to be as set forth in the following claims.

We claim:

1. A method for recouping tuition discounts extended by an academic institution, said method comprising the steps of:
identifying the institutional aid typically extended by the institution;
identifying a utilization rate according to which the institution seeks to reduce its institutional aid;
grouping the institution's prospective students into predefined income categories;
using a computer implemented segmentation algorithm to generate target percentages of students in each income category to whom the institution will offer a tuition advantage award, wherein said generation of target percentages is carried out by a computer specifically programmed to electronically perform the mathematical and logic sequences required by the segmentation algorithm;
extending a tuition advantage award to a student identified by the institution based on the results returned by the segmentation algorithm, said tuition advantage award representing a portion of the institutional aid offered to the student by the institution; and
commencing an award repayment plan after said student separates from the institution; and
implementing a back-end forgiveness feature into the repayment play, whereby upon receipt of timely repayment of the first 75% of the original principal of the award, the remaining 25% of the original award principal is forgiven.
